(19) United States
(12) Patent Application Publication
(10) Pub. No.: US 2006/0224952 A1
(43) Pub. Date: Oct. 5, 2006

(54) Adaptive layout templates for generating electronic documents with variable content

(76) Inventor: Xiaofan Lin, Sunnyvale, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/093,473

(22) Filed: Mar. 30, 2005

(51) Int. Cl. G06F 17/24; G06F 17/21

(52) U.S. Cl. 715/517

(57) ABSTRACT

Methods, systems and machine-readable instructions for processing electronic documents are described. In one aspect, a description of a static layout of logical blocks of the electronic document is received. The static layout description assigns to each of the logical blocks at least one associated static layout attribute. Each of the static layout attributes is assigned a fixed value. An adaptive layout template is generated from the static layout description. The adaptive layout template includes adaptive layout attributes corresponding to the static layout attributes and assigns to each of the adaptive layout attributes a respective symbolic expression representing a variable value. The adaptive layout template is stored in a memory.

### BACKGROUND

Electronic documents are created in many different ways. For example, desktop application programs, such as Microsoft Word, Quark Design, and Adobe InDesign, frequently are used to create electronic documents. These electronic documents contain various types of content arranged with a particular layout and style.

Oftentimes, it is desirable to preserve the graphic appearance of an electronic document. Image-based formats, such as TIFF, GIF, and JPEG, preserve the appearance of electronic documents. Electronic documents stored in such image-based formats, however, typically have large storage requirements. To reduce these storage requirements, many document analysis approaches have been developed for separating the structure of electronic documents that are stored in an image-based format from their contents. The structural information may be used to infer a semantic context that is associated with various contents in the electronic document or to convert the electronic documents into an editable file format. The static layouts of electronic documents have been described in a wide variety of different layout description formats, including XSL-FO (extensible Stylesheet Language Formatting Options), SVG (Scalable Vector Graphics), PPML (Personalized Printer Markup Language), InDesign, and QuarkXpress formats.

Template-based electronic document formats describe a predefined layout arrangement of fields that are capable of accepting variable content. In some approaches, the size, shape and placement of the template fields are fixed. In another approach, an electronic document is represented as a template that contains predefined content areas whose positions and sizes may be varied within specified ranges. In particular, the content areas are defined by variables with respective value domains that define the size, position, and content of the content areas. A user specifies constraints that limit variable ranges and define relationships between variables and values. A constraint solver generates a final document that satisfies all of the specified constraints.

In general, the templates that are used to describe the look and feel of template-based electronic documents are generated manually using a process that is labor-intensive and requires significant computer graphics skills.

### SUMMARY

In one aspect, the invention features a method of processing an electronic document in accordance with which a description of a static layout of logical blocks of the electronic document is received. The static layout description assigns to each of the logical blocks at least one associated static layout attribute. Each of the static layout attributes is assigned a fixed value. An adaptive layout template is generated from the static layout description. The adaptive layout template includes adaptive layout attributes corresponding to the static layout attributes and assigns to each of the adaptive layout attributes a respective symbolic expression representing a variable value. The adaptive layout template is stored in a memory.

The invention also features a system and machine-readable instructions for implementing the above-described electronic document processing method.

Other features and advantages of the invention will become apparent from the following description, including the drawings and the claims.

### DESCRIPTION OF DRAWINGS

FIG. 1 is a block diagram of an embodiment of a system for processing an electronic document.

FIG. 2 is a flow diagram of an embodiment of a method of processing an electronic document.

FIG. 3 is a diagrammatic view of data flow in the electronic document processing method of FIG. 2.

FIG. 4 is a flow diagram of an embodiment of a method of extracting explicit logical blocks from an input electronic document.

FIG. 5 is a diagrammatic view of an exemplary electronic document and a set of explicit logical blocks extracted from the electronic document in accordance with the method of FIG. 4.

FIG. 6 is a flow diagram of an embodiment of a method of extracting an adaptive layout from a static layout description.

FIG. 7 is a flow diagram of an embodiment of a method of generating an adaptive layout template.

FIG. 8 is a flow diagram of an embodiment of a method of generating rules constraining layout variations among implicit logical blocks to approximate the electronic document in appearance while accommodating variable content.

FIG. 9 is a flow diagram of an embodiment of a method of replacing symbolic expressions in an adaptive layout template with fixed layout attribute values.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale.

The embodiments that are described in detail below leverage static layout descriptions of electronic documents to generate adaptive layout templates from which variable-content documents may be produced. In particular, some of these embodiments convert static descriptions of the layouts of original electronic documents into adaptive layout templates that can be populated with variable content to produce new electronic documents that substantially preserve the look and feel of the original electronic documents. Some of these embodiments can convert one or multiple different types of content layout descriptions into a single adaptive layout template, thereby enabling a single set of processing modules to be used to generate variable-content documents from layout descriptions in a wide variety of different formats.

### I. GENERAL FRAMEWORK

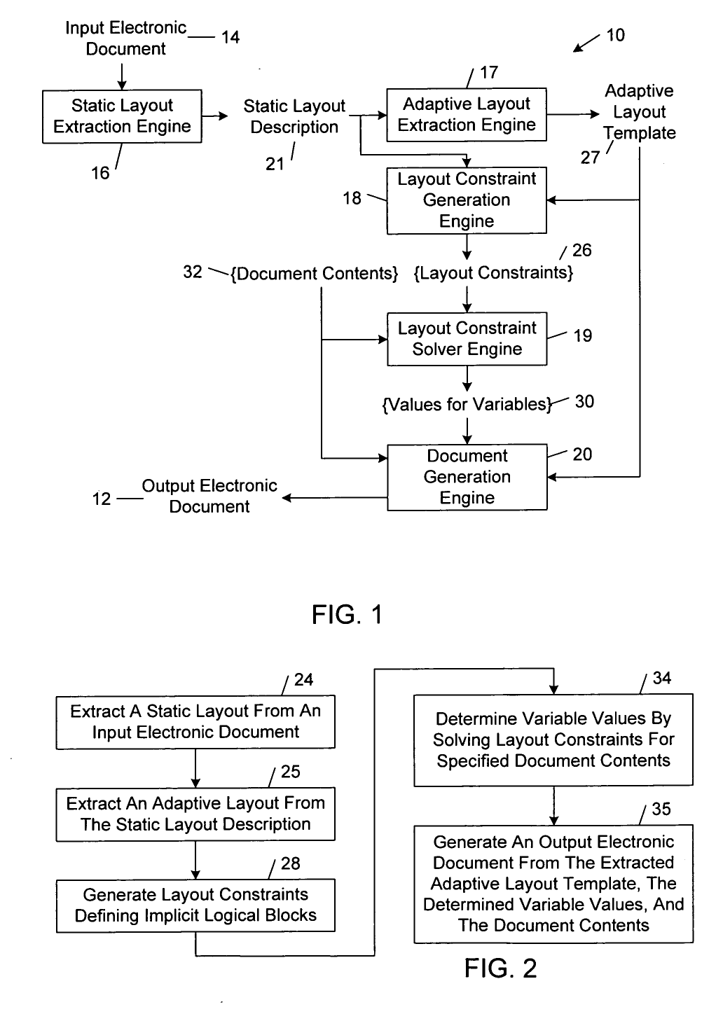

FIG. 1 shows an embodiment of an electronic document processing system 10 for generating an output electronic document 12 having substantially the same look and feel as an input electronic document 14 but containing different content.

In general, the input electronic document 14 and the output electronic document 12 may be any type of electronic document, including editable markup document (e.g., an Adobe FrameMaker document, a rich text format document, or a Microsoft Word document), formatted markup documents (e.g., an Adobe PDF document or an Adobe PostScript document), and rendered image documents (e.g., a bit map image document). Each of the input electronic document 14 and the output electronic document 12 may contain one or more pages of content. In the illustrated embodiment, the electronic document processing system 10 processes the input electronic document 14 on a page-by-page basis; although in some implementations, the electronic document processing system 10 may process a page of the input electronic document 14 based on information obtained from an analysis of one or more other pages of the input electronic document 14.

The electronic document processing system 10 includes a static layout extraction engine 16, an adaptive layout extraction engine 17, a layout constraint generation engine 18, a layout constraint solver engine 19, and a document generation engine 20. These engines 16-20 may be implemented in any computing or processing environment, including in digital electronic circuitry or in computer hardware, firmware, or software. In some embodiments, the static layout extraction engine 16, the adaptive layout extraction engine 17, the layout constraint generation engine 18, the layout constraint solver engine 19, and the document generation engine 20 are implemented by one or more respective software modules that are executed on a computer. The layout constraint solver engine 19 may be implemented by any one of a wide variety of different constraint solving systems. In the illustrated embodiments, the layout constraint solver engine 19 is implemented by a simplex-based linear solver system.

Computer process instructions for implementing the engines 16-20 and the data generated by the engines 16-20 are stored in one or more machine-readable media. Storage devices suitable for tangibly embodying these instructions and data include all forms of non-volatile memory, including, for example, semiconductor memory devices, such as EPROM, EEPROM, and flash memory devices, magnetic disks such as internal hard disks and removable disks, magneto-optical disks, and CD-ROM.

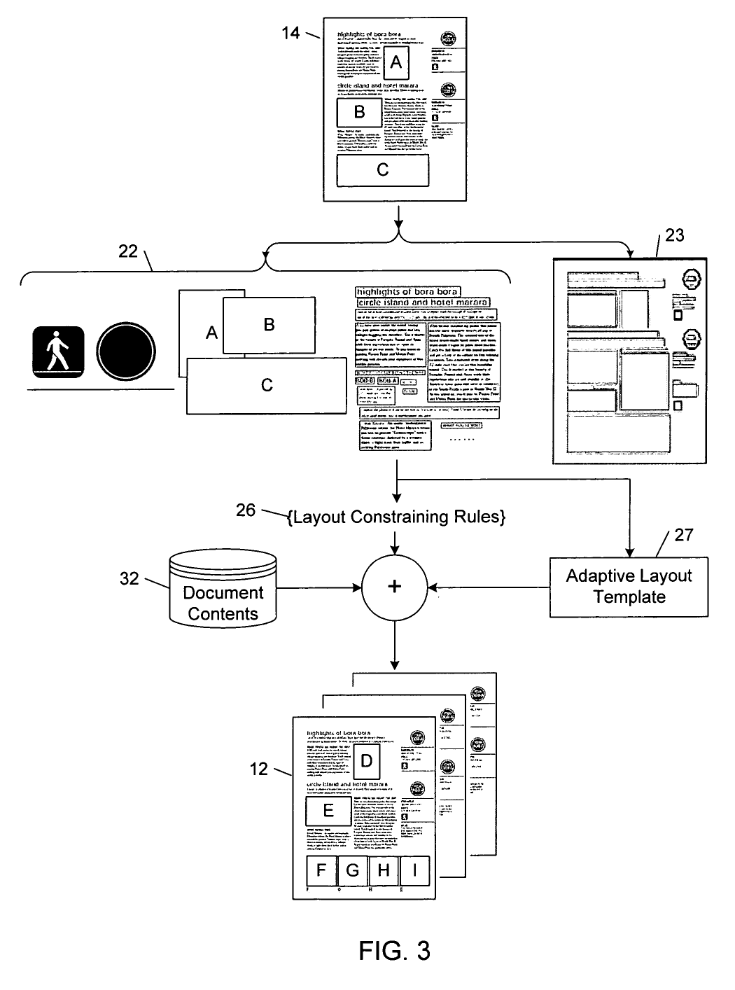

Referring to FIGS. 2 and 3, in one embodiment, the electronic document processing system 10 generates the output electronic document 12 based on an analysis of the input electronic document 14 and on specified document content, as follows.

The static layout extraction engine 16 initially extracts a static layout (i.e., explicit logical blocks 22 and their layout 23) from the input electronic document 14 (block 24; FIG. 2). In this process, the static layout extraction engine 16 identifies different explicit logical blocks in the input electronic document 14. In particular, the input electronic document 14 contains homogeneous regions having respective contents (e.g., text, images, or vector graphics) that are arranged with a particular layout and presented with a particular style. The static layout extraction engine 16 identifies these homogeneous regions as explicit logical blocks, separates the layout of the explicit logical blocks from their contents, and extracts the layout style of the identified logical blocks. The term “logical block” refers to a region of content in the electronic document that is determined to have a homogenous content style and a homogenous semantic context (e.g., document title, header, and paragraph for logical blocks containing textual content). The word “explicit” refers to the fact that the logical blocks in the input electronic document 14 are fully determined in terms of layout, style, and content.

The static layout that is generated by the static layout extraction engine 16 may be embodied in a static layout description 21 that may be formatted in accordance with one or more of a wide variety of different layout description formats, including XSL-FO (extensible Stylesheet Language Formatting Options), SVG (Scalable Vector Graphics), PPML (Personalized Printer Markup Language), InDesign, and QuarkXpress formats. The static layout description 21 contains a list of the extracted logical blocks 22 and assigns to each of the logical blocks at least one associated static layout attribute, each of which is assigned a fixed value.

After the static layout has been extracted from the input electronic document 14 (block 24; FIG. 2) and embodied in the static layout description 21, the adaptive layout extraction engine 17 extracts an adaptive layout from the static layout description 21 (block 25; FIG. 2). In the illustrated embodiments, the extracted adaptive layout is embodied in an adaptive layout template 27 that includes adaptive layout attributes that correspond to the static layout attributes in the static layout description 21. Instead of the fixed attribute values assigned by the static layout description 21, however, the adaptive layout template 27 assigns to each of the adaptive layout attributes a symbolic expression representing a variable value. This enables the adaptive layout template 27 to accommodate variable content. As used herein the term “symbolic expression” refers broadly to a mathematical or logical symbol or a meaningful combination of symbols. For example, in some cases, a symbol representing a single variable value may be assigned to an adaptive layout attribute. In other cases, a mathematical expression that includes one or more symbols representing variable values and one or more mathematical operators may be assigned to an adaptive layout attribute.

After the adaptive layout has been extracted from the input electronic document 14 (block 25; FIG. 2) and embodied in the adaptive layout template 27, the layout constraint generation engine 18 generates rules 26 that define implicit logical blocks (block 28; FIG. 2). Each of the implicit logical blocks corresponds to a respective one of the explicit logical blocks and can accommodate variable content having the content style assigned to the corresponding explicit logical block. The word “implicit” refers to the fact that the layout constraining rules 26 merely define some of the attributes of potential logical blocks; they do not assign contents nor final position coordinates to the logical blocks and therefore do not fully determine the logical blocks.

After the layout constraining rules 26 have been generated (block 28; FIG. 2), the layout constraint solver engine 19 determines the values 30 of the variables represented by the symbolic expressions in the adaptive layout template 27 by solving the layout constraints 26 for a specified set of document contents 32 that are assigned to the implicit logical blocks (block 34; FIG. 2). The layout constraint solver engine 19 may solve the constraints 26 using any one of a wide variety of different constraint solving methods, including a simplex-based linear constraint solving method.

The document generation engine 20 generates the output electronic document 12 based on the adaptive layout template 27, the symbolic expression values that were determined by the layout constraint solver engine 19, and the specified document contents 32 (block 35; FIG. 2). In this process, the document generation engine 20 populates the symbolic expressions in the adaptive layout templates with the variable values 30 that were determined by the layout constraint solver engine 19 and calculates the results of symbolic expressions corresponding to mathematical equations. The document generation engine 20 generates the output electronic document 12 by rendering the specified document contents 32 in accordance with the resulting, fully-specified layout template. As shown in FIG. 3, multiple customized output electronic documents may be generated based on the adaptive layout template 27 simply by changing the document contents that are assigned to the implicit logical blocks that were defined by the layout constraining rules 26.

### II. EXTRACTING A STATIC LAYOUT FROM AN INPUT ELECTRONIC DOCUMENT

In general, the static layout extraction engine 16 may extract explicit logical blocks from the input electronic document 14 by executing any type of logical block extraction process that segments an electronic document into logical components, separates the layout of the explicit logical blocks from their contents, and extracts a layout style of the identified logical blocks.

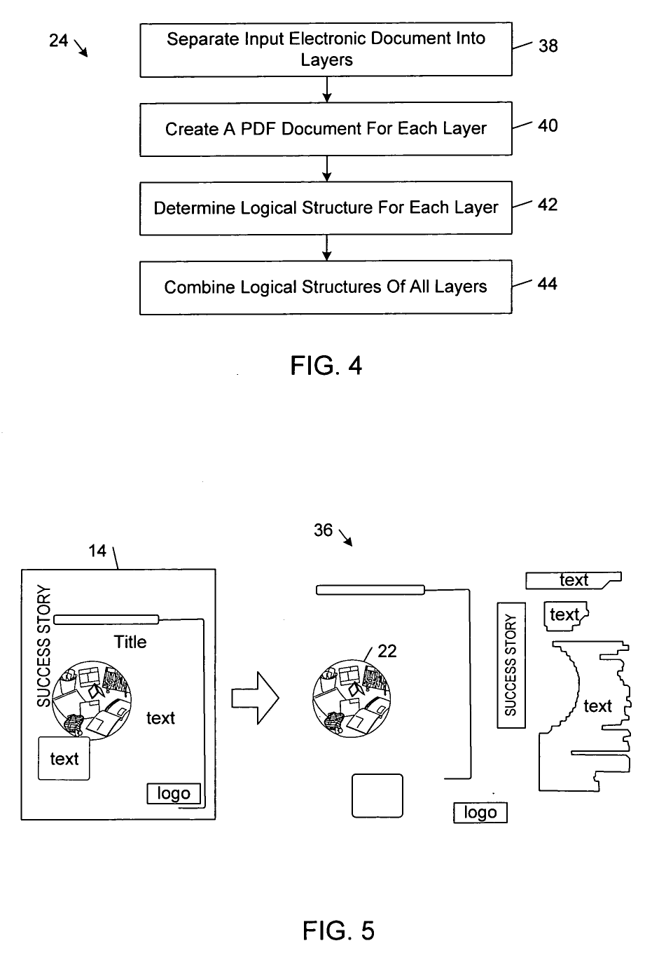

Referring to FIGS. 4 and 5, in one exemplary implementation, the static layout extraction engine 16 extracts the explicit logical blocks 22 from an input electronic document 14, as follows. In this implementation, the input electronic document 14 is encoded in the PDF file format, which includes tags for text objects, image objects, and path objects (i.e., vector graphic objects). If the input electronic document 14 describes logical blocks directly (e.g., a Microsoft Word document or an XSL-FO document), the static layout extraction engine 16 may be implemented by a file parser rather than the full-fledged intelligent layout extraction engine that is described below.

In accordance with this implementation, the static layout extraction engine 16 separates the input electronic document 14 into layers 36 based on content type (block 38). The layers may include a text layer, an image layer, and a vector graphics layer. A separate PDF document is created for each of the layers (block 40).

A logical structure is determined for each of the layers (block 42). The logical structure describes the content, layout structure, and layout style of the explicit logical blocks in a given layer. The layout style of a logical block is described by a style attribute vector, which includes an indication of the content type (e.g., text, image, or vector graphic) and a set of style attributes. In one implementation, the style attributes describe: font size, font family, color, orientation, bounding box coordinates, and outline polygon coordinates for textual content; the aspect ratio, the shape, the bounding box coordinates, and outline polygon coordinates for image content; and bounding box coordinates and outline polygon coordinates for vector graphic content. The “outline polygon” of a logical block corresponds to a polygon that encompasses and traces the outline of the content of the logical block. The “bounding box” of a logical block refers to the smallest rectangle with vertical and horizontal sides that encompasses the outline polygon of the logical block.

The logical structures of each of the layers 36 are combined to determine the logical structures of all of the layers 36 of the input electronic document 14 (block 44). In this process, the static layout extraction engine 16 determines the relative positions (page coordinates) of the explicit logical blocks of the explicit logical blocks and associates with each logical block a layer index, which determines the order in which the logical blocks are laid down on the pages of the input electronic document 14. The information (e.g., logical block content, layout, style, relative positions, and layering order) that is extracted from the input electronic document 14 may be described in XML (extensible Markup Language) and stored in a machine-readable medium. The following code segment is an exemplary static layout description of an ellipse object in the SVG format.

```
< clipPath id = “MyClip” >
< ellipse
    cx = “7.571017976588621” cy = “10.238900501672227”
    rx = “7.571017976588621” ry = “10.238900501672227”
  style = “stroke:green;fill:none”/ >
< /clipPath >
```

In this example, the cx attribute defines the x coordinate of the center of the ellipse, the cy attribute defines the y coordinate of the center of the ellipse, the rx attribute defines the horizontal radius, and the ry attribute defines the vertical radius.

Additional details regarding the explicit logical block extraction method of FIG. 4 may be obtained from U.S. patent application Ser. No. 10/787,971, which was filed Feb. 27, 2004, by Hui Chao et al., and is entitled “Method for Determining Logical Components of a Document,” and is incorporated herein by reference.

### III. EXTRACTING AN ADAPTIVE LAYOUT FROM A STATIC LAYOUT DESCRIPTION OF AN ELECTRONIC DOCUMENT

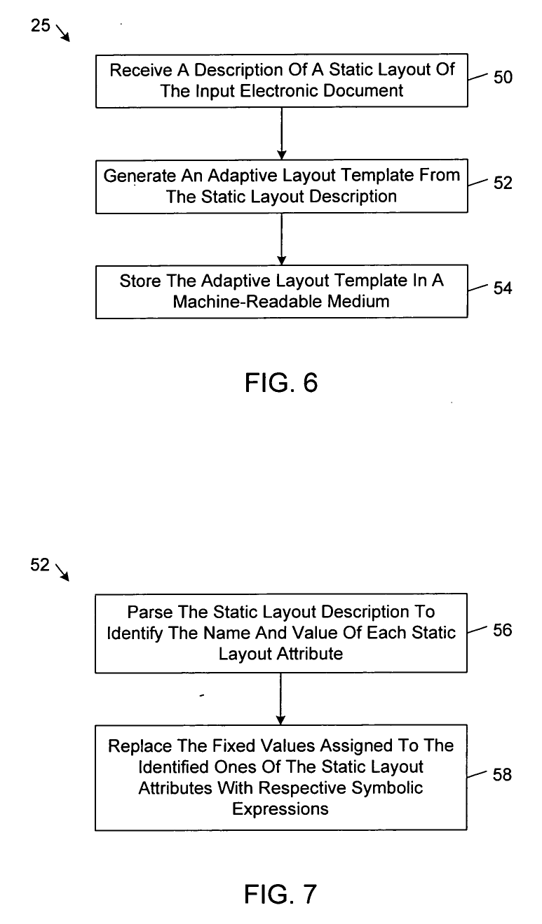

FIG. 6 shows a flow diagram of an embodiment of a method by which the adaptive layout extraction engine 17 operates. In accordance with this method, the adaptive layout extraction engine 17 receives the static layout description 21 of the input electronic document 14 from the static layout extraction engine 16 (block 50). The adaptive layout extraction engine 17 generates the adaptive layout template 27 from the static layout description 21 (block 52). The adaptive layout extraction engine 17 stores the adaptive layout template 27 in a machine-readable medium (block 54).

FIG. 7 shows a flow diagram of an embodiment of a method by which the adaptive layout extraction engine 17 generates the adaptive layout template 27 from the static layout description 21.

In accordance with this method, the adaptive layout extraction engine 17 parses the static layout description 21 to identify the names and values of each of the static layout attributes (block 56). Known Application Programming Interfaces (APIs), such as DOM (Document Object Model) and SAX (Simple API for XML), can be used for parsing. The following code illustrates how the parsing may be performed using a Java DOM API:

```
parser =
    (ParserWrapper) Class
      .forName(DEFAULT_PARSER_NAME)
      .newInstance( );
  }
  docbo = parser.parse(filename);//”filename” is the name of the
      static layout description file
```

The parsing process produces a list of the names and the values of every layout attribute in the static layout description 21.

The adaptive layout extraction engine 17 then converts the identified ones of the static layout attributes into respective ones of the adaptive layout attributes. In this process, the adaptive layout extraction engine 17 replaces the fixed values that are assigned to the identified ones of the static layout attributes with respective symbolic expressions (block 58). As explained above, the term “symbolic expression” refers broadly to a mathematical or logical symbol or a meaningful combination of symbols.

In some cases, at least some of the values of the identified attributes are replaced by respective symbols representing single variable values. The symbols may be generated randomly (e.g., randomly generated strings, such as “abc”) or systematically based on the name of the associated logical block (e.g., if a logical block is named “block1”, the height attribute value associated with block1 may be replaced with “block1_height”).

In other cases, at least some of the values of the identified attributes are replaced by mathematical equations, each of which includes one or more symbols representing variable values and one or more mathematical operators. In some implementations, the mathematical equations may be generated manually by a user of the electronic document system 10. Other implementations may include one or more layout analysis engines that generate mathematical equations for improving the visual appearance of the layout of the logical blocks 22 based on one or more heuristics.

In some implementations, during the conversion process the adaptive layout extraction engine 17 inserts into the adaptive layout template 27 one or more parser symbols that demarcate associated elements of the adaptive layout template 27. The parser symbols are recognizable by the document generation engine 20. The parser symbols serve to avoid ambiguities by clearly demarcating the locations of the symbolic expressions and additionally support expressions. Among the exemplary types of parser symbols are expression-demarcating symbols each of which identifies at least one of the symbolic expressions in the adaptive layout template 27. In some implementations, the parser symbol “##” is used to separate symbolic expressions from ordinary strings. Another type of parser symbol is a unit-demarcating symbol, which separates at least one of the symbolic expressions from an associated measurement unit. For example, in some implementations, the parser symbol “!!” is used to separate a symbolic expression from an associated measurement unit. Other parser symbols correspond to mathematical operators that appear in the mathematical equations in the adaptive layout template 27. For example, in some implementations, the parser symbol “+” is used in mathematical equations to mean that the values on either side of “+” should be added together. In general, the mathematical equations that are inserted into the adaptive layout template 27 may include any type of mathematical operator, including operators for addition, subtraction, multiplication, and division.

The code segments listed below illustrate how an exemplary implementation of the adaptive layout extraction engine 17 generates an adaptive layout template segment from a static layout description segment. The following code segment is an exemplary static layout description of a block-container object that creates a block-level reference-area for an external graphic object in the XSL-FO format.

```
  < fo:block-container height = “792pt” left = “ 0pt” position =
“absolute” top = “0pt” width = “612pt” >
  < fo:block >
      < fo:external-graphic height = “792pt” src = “ abc.svg”
      width = “612pt” / >
      < /fo:block >
      < /fo:block-container >
```

In the above-described illustrated example, the adaptive layout extraction engine 17 generates the following adaptive layout template segment from the XSL-FO code presented above.

```
  < fo:block-container height = “## + block1_height!!pt”
left = “## + block1_left!!pt” position = “absolute”
top = “## + block1_top!!pt”
width = “## + block1_width!!pt” >
  < fo:block >
    < fo:external-graphic height = “## + block1_height!!pt ”
src = “abc.svg” width = “## + block1_width!!pt ” / >
    < /fo:block >
    < /fo:block-container >
```

The values of the adaptive layout attributes in the adaptive template segment shown above are specified respectively by variable symbolic expressions.

After the adaptive layout template presented above has been generated by the adaptive layout extraction engine 17, a user may modify the adaptive layout template 27 to change or constrain the range of possible layout variations of the logical blocks in the output electronic document 12. In one illustrative example, a user may manually modify the first line in the exemplary adaptive layout template segment presented above to link the value of the width attribute (“width”) to the value (“block1_height”) of the height attribute (“height”) as follows:

< fo:block-container height = “## + block1_height!!pt”
left = “## + block1_left!!pt” position =
“absolute” top = “## + block1_top!!pt”
width = “## + block1_height + 10!!pt” >

In this example, the block-container width is equal to the height plus 10 pt.

In some implementations, the adaptive layout extraction engine 17 supports embedded files. For example, in these implementations, a user may manually embed the static layout description source file “demo20.svg” into the following adaptive layout template segment:

```
< fo:block >
    < fo:external-graphic
      height = “## + circleheight + circleheight!!pt”
      replace = “1” src = “demo20.svg”
        width = “## + circlewidth + circlewidth!!pt”/ >
  < /fo:block >
```

The parser flag “replace” controls the way in which the adaptive layout extraction engine 17 processes the source file. When the “replace” flag is set equal to “1”, as in the above example, the adaptive layout extraction engine 17 creates an adaptive layout template file (e.g., “demo20.svg.template”) in which the fixed attribute values are replaced with symbolic expressions. When the “replace” flag is set equal to “0”, the adaptive layout extraction engine does not create an adaptive layout template file from the source file. During the document generation process described in detail below, the document generation engine 20 opens the adaptive layout template file corresponding to the source file (e.g., “demo20.svg.template”), replaces the symbolic expressions with numeric values, and overwrites the source file (e.g., “demo20.svg”) with the resulting values.

After the conversion process, the adaptive layout extraction engine 17 encapsulates the logical block names, the attributes, and the symbolic expressions in the adaptive layout template 27. The resulting adaptive layout template 27 is stored in a machine-readable medium (block 54; FIG. 6).

### IV. GENERATING RULES CONSTRAINING LAYOUT VARIATIONS

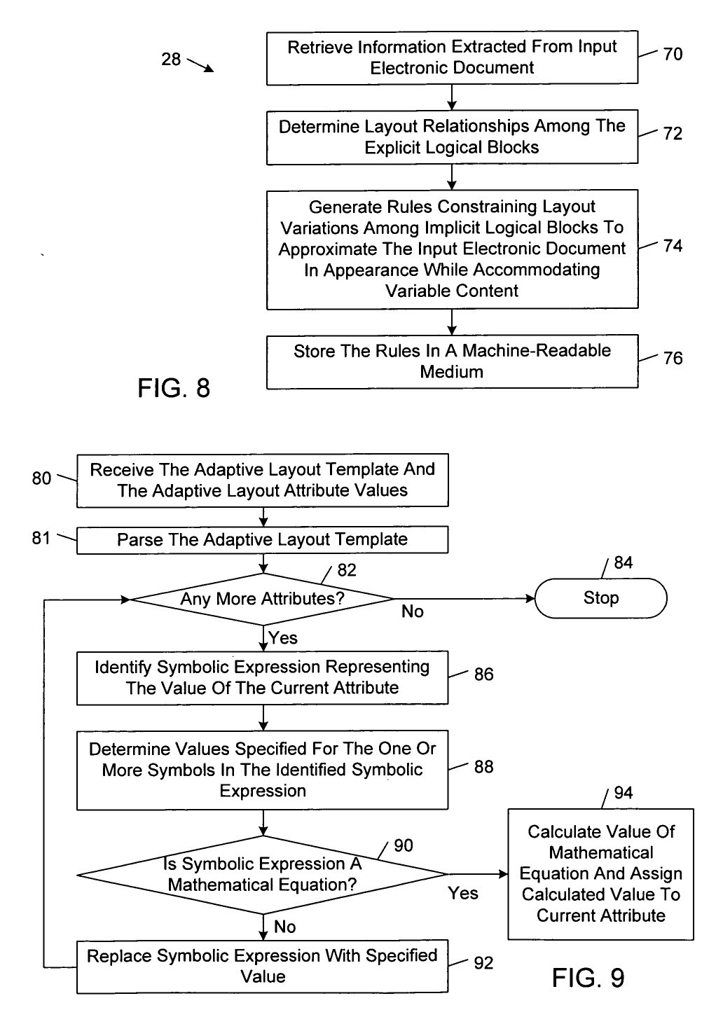

As explained above, the layout constraint generation engine 18 generates rules 26 that define implicit logical blocks (block 28; FIG. 2). FIG. 8 shows an embodiment of a method by which the layout constraint generation engine 18 generates these layout constraining rules 26.

The layout constraint generation engine 18 receives the information that is extracted from the input electronic document 14 by the static layout extraction engine 16, including logical block content, layout, style, relative positions, and layering order of the explicit logical blocks (block 70). The layout constraint generation engine 18 also retrieves the adaptive layout template 27, which specifies the names and the symbolic expressions representing the values of the adaptive layout attributes.

The layout constraint generation engine 18 then determines layout relationships among the explicit logical blocks (block 72). Among these layout relationships are gap relationships, overlap relationships, embedding relationships, and alignment relationships. The layout constraint generation engine 18 also determines relationships between the explicit logical blocks and the pages of the input electronic document 14, including page margins, content bleeding, and repetitive patterns.

Based on the determined layout relationships (block 72), the layout constraint generation engine 18 generates the rules 26 constraining layout variations among implicit logical blocks to approximate the input electronic document 14 in appearance while accommodating variable content (block 74). Each of the implicit logical blocks corresponds to a respective one of the explicit logical blocks and accommodates variable content having the content style that is assigned to the corresponding explicit logical block.

In general, the rules 26 that are generated by the layout constraint extraction engine 18 may be expressed in any suitable mathematical form that is capable of describing the layout and geometric relations among the implicit logical blocks, such as above, below, left of, right of, inside, and overlaps. In the illustrated embodiments, the layout constraining rules 26 correspond to linear equality and inequality objectives and constraints.

The layout constraint extraction engine 18 associates with each rule a strength label that is used by the layout constraint solver engine 19 to prioritize constraints when all of the constraints cannot be satisfied in a given layout of implicit logical blocks. The strength labels are selected from a predefined strength hierarchy that compasses strength labels for required constraints and non-required constraints. In one exemplary implementation, the strength hierarchy consists of the following strength labels in order of priority: required, strong, and weak. Rules that are associated with a “required” strength label are referred to herein as “required rules” and rules that are associated with “strong” or “weak” strength labels are referred to herein as “non-required rules”.

The layout constraint generation engine 18 stores the layout constraining rules 26 in a machine-readable medium (block 76).

Additional details regarding the operation of the layout constraint generation engine 18 may be obtained from U.S. patent application Ser. No. 11/055,744, which was filed Feb. 10, 2005, by Hui Chao et al., and is entitled “Constraining Layout Variations For Accommodating Variable Content In Electronic Documents,” and is incorporated herein by reference.

### V. GENERATING DOCUMENTS WITH VARIABLE CONTENT

After the layout constraint solver engine 19 determines the values 30 of the variables represented by the symbolic expressions in the adaptive layout template 27 (block 34; FIG. 2), the document generation engine 20 generates the output electronic document 12 based on the adaptive layout template 27, the symbolic expression values determined by the layout constraint solver engine 19, and the specified document contents 32 (block 35; FIG. 2). In this process, the document generation engine 20 replaces the symbolic expressions in the adaptive layout template 27 with calculated values and renders the output electronic document 12 with the specified document content laid out as specified in a fully-specified version of the adaptive layout template 27.

FIG. 9 shows an embodiment of a method by which the document generation engine 20 populates the symbolic expressions in the adaptive layout template 27 with the variable values 30 that were determined by the layout constraint solver engine 19 and calculates the results of any mathematical equations in the adaptive layout template 27.

In accordance with this method, the document generation engine 20 retrieves the adaptive layout template 27 and the adaptive layout attribute values, which were determined by the layout constraint solver engine 19, from the machine-readable media where they are stored (block 80). The document generation engine 20 parses the adaptive layout template 27 for attributes and their associated symbolic value expressions (block 81). In some implementations, the APIs described above are used to parse the adaptive layout template 27. If there are no more attributes in the adaptive layout template 27 for the document generation engine 20 to process (block 82), the document generation engine 20 stops processing the adaptive layout template 27 (block 84). In some implementations, the document generation engine 20 includes a parser that is able to recognize the parser symbols in the adaptive layout template 27. In these implementations, the parser may identify each attribute by locating the parser symbol “##”.

If there are additional attributes to process (block 82), the document generation engine 20 identifies the symbolic expression representing the value of the current adaptive layout attribute (block 86). In some implementations, the symbolic expressions are located between the parser symbols “##” and “!!”. The document generation engine 20 determines which of the attribute values that were determined by the layout constraint solver engine 19 correspond to the one or more symbols in the identified symbolic expression (block 88).

If the identified symbolic expression is not a mathematical equation (block 90), the document generation engine 20 replaces the symbolic expression with the specified attribute value (block 92). In this process, the document generation engine 20 also removes the parser symbols “##” and “!!”. If the identified symbolic expression is a mathematical equation (block 90), the document generation engine 20 calculates the value of the mathematical equation and assigns the calculated value to the current adaptive layout attribute. In this process, the document generation engine 20 replaces the mathematical equation with the calculated value and removes the parser symbols “##” and “!!”.

After the symbolic expressions in the adaptive layout template 27 have been replaced with calculated values, the resulting adaptive layout template 27 fully specifies the layout of output electronic document 12. The document generation engine 20 can therefore generate the output electronic document 12 by rendering the specified document contents in accordance with the layout attributes specified in the resulting fully-specified layout template.

### VI. CONCLUSION

To summarize, the embodiments described above provide ways to leverage static layout descriptions of electronic documents to generate adaptive layout templates from which variable-content documents may be produced.

What is claimed is:

1. A method of processing an electronic document, comprising:
receiving a description of a static layout of logical blocks of the electronic document, wherein the static layout description assigns to each of the logical blocks at least one associated static layout attribute, and each static layout attribute is assigned a fixed value;
generating from the static layout description an adaptive layout template comprising adaptive layout attributes corresponding to the static layout attributes and assigning to each of the adaptive layout attributes a respective symbolic expression representing a variable value; and
storing the adaptive layout template in a memory.

2. The method of claim 1, wherein the generating comprises parsing the static layout description to identify the static layout attributes.

3. The method of claim 2, wherein the generating comprises converting the identified ones of the static layout attributes into respective ones of the adaptive layout attributes.

4. The method of claim 3, wherein the converting comprises replacing the fixed values assigned to the identified ones of the static layout attributes with respective ones of the symbolic expressions.

5. The method of claim 4, wherein the replacing comprises replacing the fixed value assigned to at least one of the identified ones of the static layout attributes with a respective symbol.

6. The method of claim 4, wherein the replacing comprises replacing the fixed value assigned to at least one of the identified ones of the static layout attributes with a respective mathematical equation comprising at least one symbol and at least one mathematical operator.

7. The method of claim 4, wherein at least one of the symbolic expressions is assigned to a first one of the identified adaptive layout attributes and comprises at least one symbol assigned to a second one of the identified adaptive layout attributes.

8. The method of claim 3, wherein each of the logical blocks in the static layout description has a respective name, and the converting comprises automatically naming the adaptive layout attributes based on the names of the associated logical blocks.

9. The method of claim 1, wherein the generating additionally comprises inserting into the adaptive layout template at least one parser symbol demarcating an associated element of the adaptive layout template.

10. The method of claim 9, wherein the inserting comprises inserting into the adaptive layout template an expression-demarcating symbol identifying at least one of the symbolic expressions.

11. The method of claim 9, wherein the inserting comprises inserting into the adaptive layout template a unit-demarcating symbol separating at least one of the symbolic expressions from an associated measurement unit.

12. The method of claim 1, wherein the generating additionally comprises inserting into the adaptive layout template an embedded source file, and further comprising creating a source template file comprising template attributes corresponding to layout attributes of the source file and assigning to each of the template attributes a respective symbolic expression representing a variable value.

13. The method of claim 1, further comprising parsing the adaptive layout template to identify the symbolic expressions assigned to the adaptive layout attributes.

14. The method of claim 13, wherein the parsing comprises identifying parser symbols demarcating associated elements of the adaptive layout template.

15. The method of claim 13, further comprising replacing identified ones of the symbolic expressions with specified values.

16. The method of claim 15, wherein at least one of the identified symbolic expressions comprises a mathematical equation, and the replacing comprises evaluating the mathematical equation to calculate a value and replacing the at least one identified symbolic expression with the calculated value.

17. The method of claim 1, further comprising retrieving a source template file corresponding to a source file embedded in the adaptive layout template, parsing the source template file to identify symbolic expressions assigned to adaptive layout attributes, and replacing identified ones of the symbolic expressions in the source template file with specified values.

18. A machine for processing an electronic document, comprising an adaptive layout extraction engine configured to:
receive a description of a static layout of logical blocks of the electronic document, wherein the static layout description assigns to each of the logical blocks at least one associated static layout attribute, and each static layout attribute is assigned a fixed value;
generate from the static layout description an adaptive layout template comprising adaptive layout attributes corresponding to the static layout attributes and assigning to each of the adaptive layout attributes a respective symbolic expression representing a variable value; and
store the adaptive layout template in a memory.

19. The machine of claim 18, wherein the adaptive layout extraction engine is configured to parse the static layout description to identify the static layout attributes and replace the fixed values assigned to the identified ones of the static layout attributes with respective ones of the symbolic expressions.

20. The machine of claim 19, wherein the adaptive layout extraction engine is configured to replace the fixed value assigned to at least one of the identified ones of the static layout attributes with a respective symbol.

21. The machine of claim 19, wherein the adaptive layout extraction engine is configured to replace the fixed value assigned to at least one of the identified ones of the static layout attributes with a respective mathematical equation comprising at least one symbol and at least one mathematical operator.

22. The machine of claim 18, wherein the adaptive layout extraction engine is configured to insert into the adaptive layout template at least one parser symbol demarcating an associated element of the adaptive layout template.

23. The machine of claim 18, wherein the adaptive layout extraction engine is configured to parse the adaptive layout template to identify the symbolic expressions assigned to the adaptive layout attributes.

24. The machine of claim 23, wherein the adaptive layout extraction engine is configured to replace identified ones of the symbolic expressions with specified values.

25. The machine of claim 24, wherein at least one of the identified symbolic expressions comprises a mathematical equation, and the adaptive layout extraction engine is configured to evaluate the mathematical equation to calculate a value and replacing the at least one identified symbolic expression with the calculated value.

26. A machine-readable medium storing machine-readable instructions for causing a machine to perform operations comprising:
receiving a description of a static layout of logical blocks of the electronic document, wherein the static layout description assigns to each of the logical blocks at least one associated static layout attribute, and each static layout attribute is assigned a fixed value;
generating from the static layout description an adaptive layout template comprising adaptive layout attributes corresponding to the static layout attributes and assigning to each of the adaptive layout attributes a respective symbolic expression representing a variable value; and
storing the adaptive layout template in a memory.

27. The machine-readable medium of claim 26, wherein the machine-readable instructions cause the machine to perform operations comprising parsing the static layout description to identify the static layout attributes and replacing the fixed values assigned to the identified ones of the static layout attributes with respective ones of the symbolic expressions.

28. The machine-readable medium of claim 27, wherein the machine-readable instructions cause the machine to perform operations comprising replacing the fixed value assigned to at least one of the identified ones of the static layout attributes with a respective symbol.

29. The machine-readable medium of claim 27, wherein the machine-readable instructions cause the machine to perform operations comprising replacing the fixed value assigned to at least one of the identified ones of the static layout attributes with a respective mathematical equation comprising at least one symbol and at least one mathematical operator.

30. The machine-readable medium of claim 26, wherein t the machine-readable instructions cause the machine to perform operations comprising inserting into the adaptive layout template at least one parser symbol demarcating an associated element of the adaptive layout template.

31. The machine-readable medium of claim 26, wherein the machine-readable instructions cause the machine to perform operations comprising parsing the adaptive layout template to identify the symbolic expressions assigned to the adaptive layout attributes.

32. The machine-readable medium of claim 31, wherein the machine-readable instructions cause the machine to perform operations comprising replacing identified ones of the symbolic expressions with specified values.

33. The machine-readable medium of claim 32, wherein at least one of the identified symbolic expressions comprises a mathematical equation, and the machine-readable instructions cause the machine to perform operations comprising evaluating the mathematical equation to calculate a value and replacing the at least one identified symbolic expression with the calculated value.

34. A system for processing an electronic document, comprising:
means for receiving a description of a static layout of logical blocks of the electronic document, wherein the static layout description assigns to each of the logical blocks at least one associated static layout attribute, and each static layout attribute is assigned a fixed value;
means for generating from the static layout description an adaptive layout template comprising adaptive layout attributes corresponding to the static layout attributes and assigning to each of the adaptive layout attributes a respective symbolic expression representing a variable value; and
means for storing the adaptive layout template in a memory.
